(19) United States
(12) Patent Application Publication
(10) Pub. No.: US 2014/0217847 A1
(43) Pub. Date: Aug. 7, 2014

(54) BRUSHLESS PERMANENT MAGNET MOTOR

(71) Applicant: Johnson Electric S.A., Murten (CH)

(72) Inventors: Wai Lun Allan KWAN, Hong Kong (CN); Jie CHAI, Hong Kong (CN); Tao ZHANG, Shenzhen (CN); Jingping TAO, Shenzhen (CN)

(73) Assignee: Johnson Electric S.A., Murten (CH)

(21) Appl. No.: 14/172,023

(22) Filed: Feb. 4, 2014

(30) Foreign Application Priority Data
Feb. 4, 2013 (CN) 201310043646.3

(51) Int. Cl. H02K 1/27

(52) U.S. Cl. CPC H02K 1/2793
USPC 310/156.38

(57) ABSTRACT

A brushless permanent magnet electric motor (10) configured to have high saliency and low cogging torque, comprises a stator (30) having a plurality of stator teeth (36), and a rotor (50) having a permanent magnet (56) having a plurality of magnetic poles. The stator teeth (36) contain pole heads (37) having grooves (39) substantially parallel to the axial direction of the motor (10) formed thereon, which function to increase the number of magnetic stator poles of the motor (10), increasing saliency. The permanent magnet (56) contains a plurality of notches (58) on one side positioned between the plurality of magnetic poles, configured to decrease the coefficient of pole arc of the rotor (50), thereby decreasing cogging torque.

### CROSS REFERENCE TO RELATED APPLICATION(S)

This application claims the benefit of Chinese patent application serial no. 201310043646.3, filed on Feb. 4, 2013. The entire content of the aforementioned patent application is hereby incorporated by reference for all purposes.

### BACKGROUND

Many existing actuators typically comprise a brushless permanent magnet motor using a Hall Effect sensor for detecting the positions of the permanent magnet. The desire to decrease material costs has spurred the development in the industry towards brushless permanent magnet motors without a Hall Effect sensor. In order to better detect the position of the actuator, it is generally desirable for the difference in inductance between the motor stator windings (the ratio between the maximum inductance and minimum inductance of the stator windings), or saliency, to be large. At the same time, it is desirable for the cogging torque of the motor to be small because high cogging torque would create undesirable vibration and noise during motor operation. Satisfying both of these requirements is difficult for many current brushless permanent magnet motors.

For example, an existing nine pole ten slot brushless permanent magnet electric motor may be able to satisfy the cogging torque requirement. However, due to the number of slots being close to the number of poles, the desired saliency cannot be achieved. Similarly, brushless permanent magnet electric motors able to achieve a desirable saliency, such as a four pole six slot brushless permanent magnet electric motor, typically exhibit high cogging torque.

Accordingly, there exists a need for a brushless permanent magnet motor able to have both high saliency and low cogging torque.

### SUMMARY

Some embodiments are directed at a brushless permanent magnet electric motor configured to have high saliency and low cogging torque. The brushless permanent magnet electric motor comprises a stator having a plurality of stator teeth defining a plurality of winding slots, and a rotor having a permanent magnet defining a plurality of magnetic poles configured to rotate relative to the stator. In some embodiments, each of the stator teeth contains a pole head with a plurality of grooves. The grooves are configured to be substantially parallel to the axial direction of the motor, and function to increase the number of magnetic stator poles of the motor, thereby lowering cogging torque without lowering saliency. In some embodiments, the permanent magnet is substantially annular, and contains a plurality of notches on one side positioned between adjacent pairs of magnetic poles. The notches are configured to increase the coefficient of pole arc or pole embrace of the rotor, in order to decrease the cogging torque of the motor.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered which are illustrated in the accompanying drawings. These drawings depict only exemplary embodiments and are not therefore to be considered limiting of the scope of the claims.

FIGS. 1A and 1B illustrate a brushless permanent magnet motor in accordance with some embodiments.

FIG. 2 illustrates a stator core for a brushless permanent magnet motor in accordance with some embodiments.

FIGS. 3A, 3B, and 3C illustrate a permanent magnet for a brushless permanent magnet motor in accordance with some embodiments.

### DETAILED DESCRIPTION

Various features are described hereinafter with reference to the figures. It shall be noted that the figures are not drawn to scale, and that the elements of similar structures or functions are represented by like reference numerals throughout the figures. It shall also be noted that the figures are only intended to facilitate the description of the features for illustration and explanation purposes, unless otherwise specifically recited in one or more specific embodiments or claimed in one or more specific claims. The drawings figures and various embodiments described herein are not intended as an exhaustive illustration or description of various other embodiments or as a limitation on the scope of the claims or the scope of some other embodiments that are apparent to one of ordinary skills in the art in view of the embodiments described in the Application. In addition, an illustrated embodiment need not have all the aspects or advantages shown.

An aspect or an advantage described in conjunction with a particular embodiment is not necessarily limited to that embodiment and may be practiced in any other embodiments, even if not so illustrated, or if not explicitly described. Also, reference throughout this specification to “some embodiments” or “other embodiments” means that a particular feature, structure, material, process, or characteristic described in connection with the embodiments is included in at least one embodiment. Thus, the appearances of the phrase “in some embodiments”, “in one or more embodiments”, or “in other embodiments” in various places throughout this specification are not necessarily referring to the same embodiment or embodiments.

Some embodiments are directed at a brushless permanent magnet electric motor configured to have high saliency and lower cogging torque. The brushless permanent magnet electric motor comprises a stator having a plurality of stator teeth defining a plurality of winding slots, and a rotor having a permanent magnet defining a plurality of magnetic poles configured to rotate relative to the stator. In some embodiments, each of the stator teeth contains a pole head with a plurality of grooves. The grooves are configured to be substantially parallel to the axial direction of the motor, and function to increase the number of magnetic stator poles of the motor, thereby lowering cogging torque without lowering saliency. In some embodiments, the permanent magnet is substantially annular, and contains a plurality of notches on one side positioned between the magnetic poles. The notches are configured to increase the pole arc coefficient of the rotor, in order to decrease cogging torque.

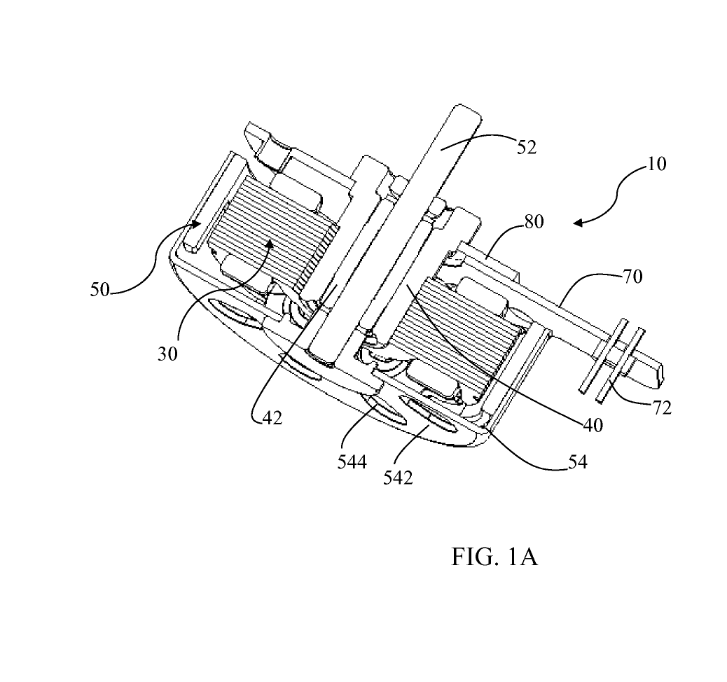

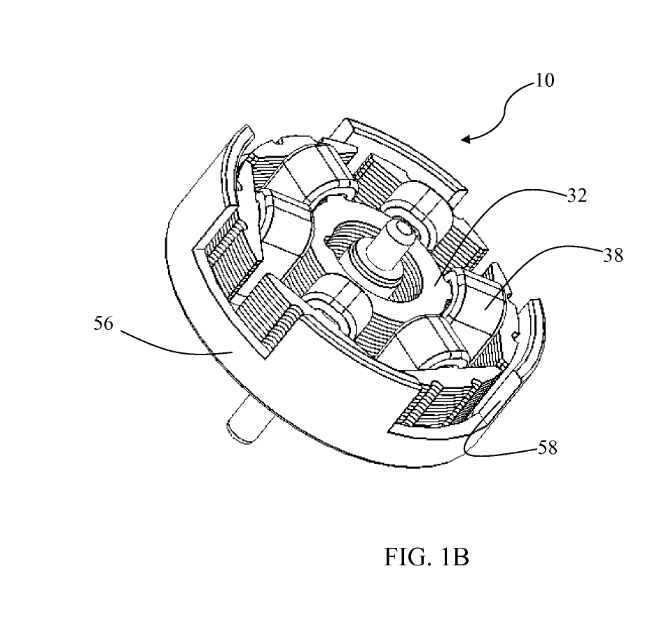

FIGS. 1A and 1B illustrate a brushless permanent magnet motor 10 in accordance with some embodiments. Motor 10 comprises a stator 30 and a rotor 50 configured to rotate relative to stator 30. In the illustrated embodiment, motor 10 is configured to have an outer rotor 50 rotating around an inner stator 30. It is understood that in other embodiments, an internal rotor configuration, wherein the rotor is configured to rotate within the stator, may be used.

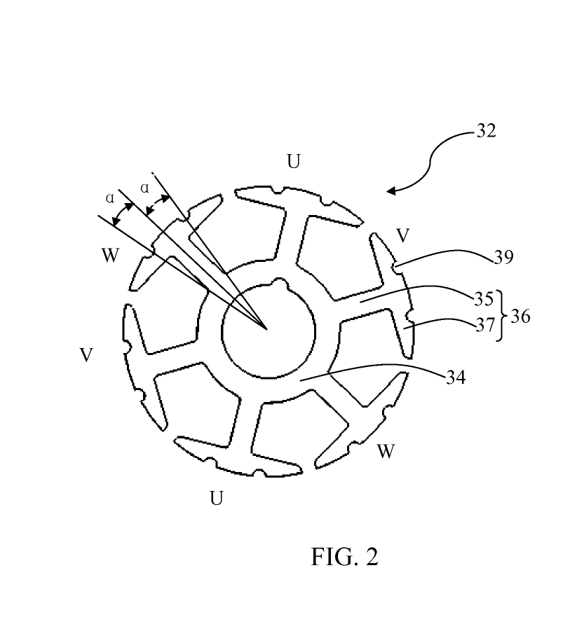

In some embodiments, stator 30 comprises a core 32, which may be formed from a magnetic material (e.g., iron). FIG. 2 illustrates stator core 32 comprising a substantially annular central portion 34, and a plurality of stator teeth 36 extending radially outwards from central portion 34. Adjacent pairs of stator teeth 36 define a plurality of winding slots. For example, stator core 32 illustrated in FIG. 2 comprises six stator teeth 36 defining six winding slots.

In some embodiments, stator windings 38 comprise a plurality of winding coils wrapped around the plurality of stator teeth 36. For example, each stator tooth 36 may have one winding coil wrapped around it, wherein each of the coils are wound around each stator tooth 36 a number of turns, and the sides of the coil are accommodated in the winding slots on either side of stator tooth 36. During motor operation, electric current flowing through the winding coils of stator windings 38 create magnetic fields that define a plurality of stator magnetic poles.

In some embodiments, each stator tooth 36 comprises a base or a stem 35 extending radially from central portion 34 and a pole head 37 on an end of stem 35 remote from central portion 34 and extending circumferentially to either side of stem 35. Pole heads 37 of stator teeth 36 contain, on the outer surface facing away from central portion 34 and towards rotor 50, one or more slots or open grooves 39 (hereinafter, collectively “grooves”) extending substantially in the axial direction of motor 10. It should be understood that the term “substantially,” such as in “substantially in the axial direction” is used herein to indicate certain features, can refer to either an exact feature or a feature that is slightly offset or otherwise not perfect. For example, grooves 39 may extend perfectly parallel to the axial direction of motor 10, or be slightly offset from being exactly parallel to the axial direction of motor 10.

Each groove 39 may be offset from the center of its associated stator tooth 36 by an angle α (corresponding to the angle between a line connecting the center of stator core 32 and the center of groove 39, and the center line of stator tooth 36). In the illustrated embodiment, angle α is configured to be approximately 10 degrees (°). The radius of each groove 39 may be configured to approximately 0.75 millimeters (mm).

The effect of grooves 39 is to increase the effective number of stator poles of stator 30. For example, stator core 32 in the illustrated embodiment comprises six stator teeth 36, wherein the pole head 37 of each stator tooth 36 contains two grooves 39. Thus, each stator tooth 36 forms the equivalent of three stator poles, such that stator core 32 forms a total of eighteen stator poles. When the number of stator poles is not equal to an integer multiple of the number of rotor poles (increasing the smallest common multiple of the number of stator and rotor poles), the amount of cogging torque experienced by the motor is reduced. The six winding coils of stator windings 38 may be formed into three phases (U, V, W), each phase wound around two stator teeth 36 on opposite sides of stator core 32.

Rotor 50 comprises an output shaft 52 and a permanent magnet 56. In some embodiments, a substantially cylindrical rotor housing 54 made of a magnetic material may be attached to output shaft 52. Permanent magnet 56 may be attached to an inner surface of cylindrical rotor housing 54 and be substantially annular in form. In the illustrated embodiment, permanent magnet 56 is configured to be disposed around stator 30, with an air gap located between permanent magnet 56 and stator 30, such that rotor 50 is able rotate around stator 30.

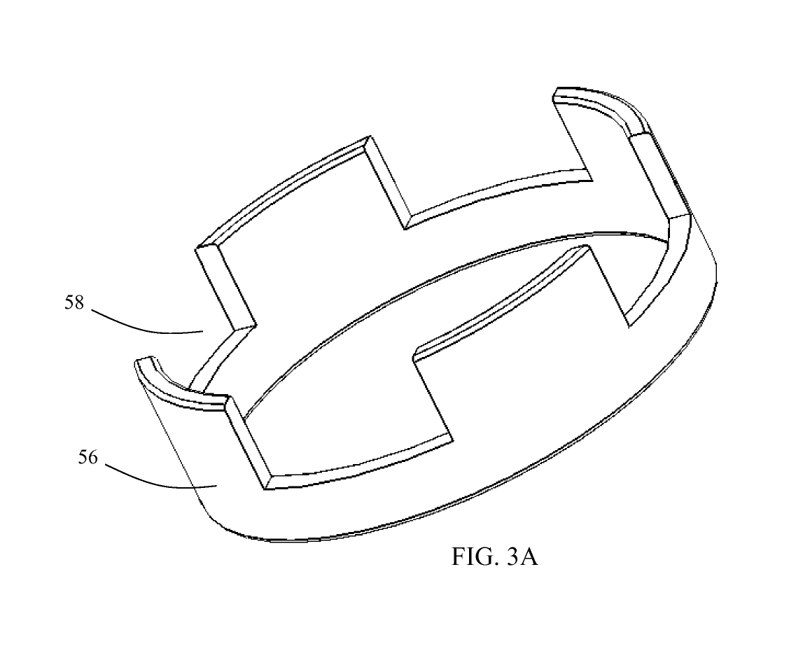

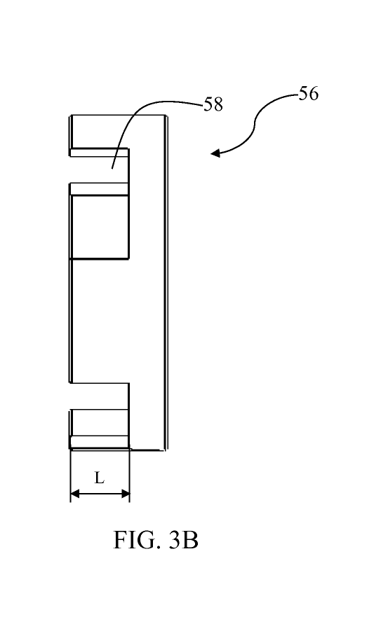

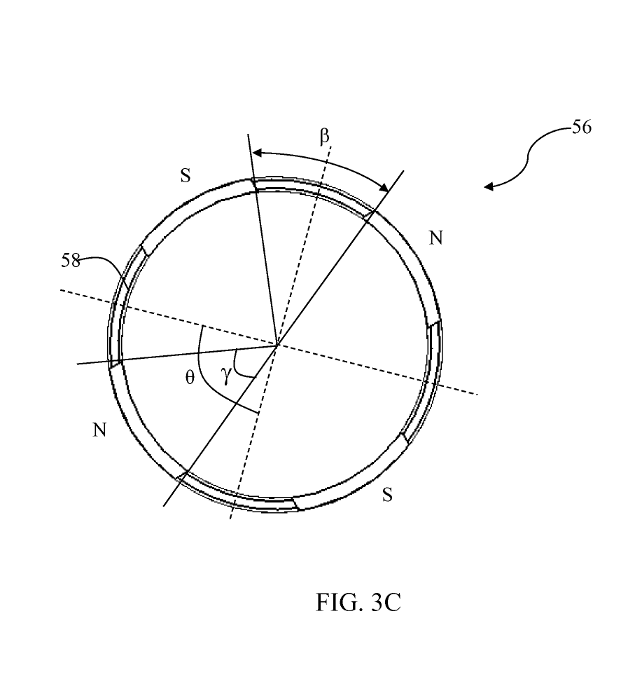

FIGS. 3A-C illustrate permanent magnet 56 in accordance with some embodiments. In the illustrated embodiment, permanent magnet 56 is a single annular permanent magnet. In other embodiments, permanent magnet 56 may comprise multiple pieces. Permanent magnet 56 forms four alternating poles (north and south) arranged circumferentially, wherein each pole is polarized in the radial direction. One axial end of the annular magnet 56 contains a plurality of notches 58, which may be evenly spaced circumferentially around annular magnet 56. Preferably, notches 58 are configured to be the same size, wherein each notch 58 is located between two adjacent magnetic poles, such that the boundary of two adjacent magnetic poles is located in the center of adjacent notches 58 sandwiched there between.

Notches 58 function to lower the coefficient of pole arc or pole embrace of motor 10. As illustrated in FIG. 3C, the pole embrace is defined as the ratio between the arc angle γ corresponding to the section of the annular magnet 56 between adjacent pairs of notches 58, and the arc angle θ corresponding to a magnetic pole. The lower coefficient of pole arc or pole embrace results in a decreased cogging torque of the motor, and consequently also decreases the detent torque of motor 10, which is equal to the sum of the cogging torque and frictional torque of the motor.

Through measurement and experimentation by the inventors, it has been found that when using a four pole six slot motor 10, wherein stator teeth 36 each have an pole head 37 with two grooves 39, and notches 58 in annular magnet 56 each define an arc angle β of between 30° and 45°, the maximum cogging torque of motor 10 is greatly reduced, with the maximum value of the detent torque being 2.0 milli-Newton meter (mNm) or less. The saliency, defined as the ratio between the maximum inductance and minimum inductance of the stator windings for each rotation of rotor 50, is greater than 1.3.

For instance, Table 1 illustrates measurements for a four pole six slot motor 10, wherein notches 58 define an arc angle β of 45°, and have a depth or axial length L of 4.5 millimeters (mm) As can been seen for the measured results, the maximum values of the detent torque (and thus also the cogging torque) are 1.8 mNm or less, with the majority of the measured motors having detent torque of 1.6 mNm or less. In addition, the saliency exceeds 1.45 for all measurements.

TABLE 1

| Motor | 1 | | | 2 | | | 3 | | | 4 | | |
|---|---|---|---|---|---|---|---|---|---|---|---|---|
| Winding Group | U-V | V-W | U-W | U-V | V-W | U-W | U-V | V-W | U-W | U-V | V-W | U-W |
| Lmax (mH) | 11.8 | 11.9 | 12.0 | 12.0 | 11.8 | 12.2 | 11.6 | 11.7 | 11.7 | 11.8 | 11.6 | 12.0 |
| Lmin (mH) | 8.0 | 8.0 | 8.1 | 8.2 | 8.1 | 8.2 | 8.0 | 7.8 | 7.8 | 8.2 | 7.8 | 8.2 |
| Lmax/Lmin | 1.48 | 1.49 | 1.48 | 1.46 | 1.46 | 1.49 | 1.45 | 1.5 | 1.5 | 1.45 | 1.49 | 1.46 |

| | | | | |
|---|---|---|---|---|
| Detent Torque | 1.6 | 1.6 | 1.8 | 1.6 |
| (mNm) | | | | |

As illustrated in FIG. 1A, rotor housing 54 may be substantially cylindrical or bowl-shaped, and be configured open on one end and with an end cap 542 on one end. A plurality of apertures or through holes 544 may be provided on end cap 542, which allow air to flow inside motor 10 in order to provide cooling to stator core 32 and winding groups 38.

Motor 10 may further comprise a circuit board 70 and/or a cover board 80 on an open end of rotor housing 54. Circuit board 70 and cover board 80 may be configured to be axially spaced apart from the stator windings 38, and be positioned such that circuit board 70 is adjacent to an inner surface of cover board 80. Circuit board 70 may be configured to connect to an external power supply through connection terminals 72, and to supply power to stator windings 38 during motor operation.

Stator 30 may further comprise a sleeve 40 located within the central portion 34 of stator core 32. Output shaft 52 of rotor 50 may be configured to pass through one or more bearings 42 rotatably mounted to sleeve 40. In some embodiments, bearings 42 comprise a bushing bearing. Cover board 80 may be attached to sleeve 40, and circuit board 70 fixed to the inner surface of cover board 80.

While the illustrated embodiments depict a four pole six slot electric motor, different motor configurations may be used for other embodiments, such as six pole seven slot motors, six pole nine slot motors, eight pole twelve slot motors, or any other type of brushless permanent magnet motor having a high saliency.

In the foregoing specification, various aspects have been described with reference to specific embodiments thereof. It will, however, be evident that various modifications and changes may be made thereto without departing from the broader spirit and scope of various embodiments described herein. For example, the above-described systems or modules are described with reference to particular arrangements of components. Nonetheless, the ordering of or spatial relations among many of the described components may be changed without affecting the scope or operation or effectiveness of various embodiments described herein. In addition, although particular features have been shown and described, it will be understood that they are not intended to limit the scope of the claims or the scope of other embodiments, and it will be clear to those skilled in the art that various changes and modifications may be made without departing from the scope of various embodiments described herein. The specification and drawings are, accordingly, to be regarded in an illustrative or explanatory rather than restrictive sense. The described embodiments are thus intended to cover alternatives, modifications, and equivalents.

1. A brushless permanent magnet electric motor, comprising:
a stator, comprising:
a stator core having a central potion and a plurality of stator teeth extending outwards from the central portion, and
a plurality of stator windings wrapped around the plurality of stator teeth; and
a substantially annular permanent magnet configured to rotate relative to the stator, defining a plurality of magnetic poles, and having a plurality of notches for on an axial side thereof.

2. The electric motor of claim 1, wherein the substantially annular permanent magnet is positioned around the stator.

3. The electric motor of claim 1, wherein a stator tooth of the plurality of stator teeth of the stator core comprises a base and a pole head on an end of the base remote from the central portion of the stator core.

4. The electric motor of claim 3, wherein the pole head of the stator teeth comprises a plurality of grooves on a surface remote from the central portion of the stator core and extending along an axial direction of the motor.

5. The electric motor of claim 4, wherein the plurality of grooves are configured to increase a number of stator magnetic poles defined by the stator.

6. The electric motor of claim 4, wherein the pole head comprises two grooves.

7. The electric motor of claim 6, wherein each of the two grooves is offset from a center of the pole head by approximately 10°.

8. The electric motor of claim 6, wherein each of the two grooves is an arc having a radius of approximately 0.75 millimeter.

9. The electric motor of claim 1, wherein the stator core comprises six stator teeth.

10. The electric motor of claim 1, wherein the plurality of notches are configured to lower a coefficient of pole arc of the substantially annular permanent magnet.

11. The electric motor of claim 1, wherein the substantially annular permanent magnet defines four magnetic poles.

12. The electric motor of claim 11, wherein the substantially annular permanent magnet comprises four notches.

13. The electric motor of claim 12, wherein each of the four notches defines an arc angle of between 30° and 45°.

14. The electric motor of claim 1, wherein an axial depth of each of the plurality notches in the substantially annular permanent magnet is approximately 4.5 millimeters.

15. The electric motor of claim 1, wherein a notch of the plurality of notches in the substantially annular permanent magnet is located between a corresponding pair of adjacent magnetic poles.

16. The electric motor of claim 15, wherein the notch is centered on a midpoint between the corresponding pair of adjacent magnetic poles.

17. A brushless permanent magnet electric motor, comprising:
a stator, comprising:
a stator core having a central portion, a plurality of stator teeth extending outwards from the central portion, wherein a stator tooth of the plurality of stator teeth comprises an pole head having a plurality of grooves on an end thereof remote from the central portion; and
stator windings wrapped around the plurality of stator teeth; and
a permanent magnet rotor configured to rotate relative to the stator and defining a plurality of magnetic poles.

18. The electric motor of claim 17, wherein the permanent magnet rotor is substantially annular and contains a plurality of notches.

19. The electric motor of claim 17, wherein the plurality of grooves on the permanent magnet rotor are configured to be parallel to an axial direction of the motor.

20. The electric motor of claim 17, wherein:
the stator core comprises six stator teeth;
the pole head on the stator tooth has two grooves; and
the permanent magnet rotor defines four poles.
